(19) United States
(12) Patent Application Publication
(10) Pub. No.: US 2024/0012669 A1
(43) Pub. Date: Jan. 11, 2024

(54) RECOVERY OF MANAGEMENT APPLIANCE AFTER UPGRADE FAILURE WITHOUT CREATING DATA INCONSISTENCIES

(71) Applicant: VMWARE, INC., Palo Alto, CA (US)

(72) Inventors: KUNDAN SINHA, Bangalore (IN); SYED ANWAR, Bangalore (IN); KIRAN RAMAKRISHNA, Bangalore (IN); SHALINI KRISHNA, Bangalore (IN); KEENAN WESTON MATHENY, Firestone, CO (US)

(21) Appl. No.: 17/896,233

(22) Filed: Aug. 26, 2022

(30) Foreign Application Priority Data
Jul. 7, 2022 (IN) 202241039112

(51) Int. Cl. G06F 9/455

(52) U.S. Cl. CPC G06F 9/45558; G06F 2009/4557; G06F 2009/45579

(57) ABSTRACT

Consistency in data that are replicated across a group of management appliances is preserved even when one of the management appliances is reverted to a snapshot thereof. A method of preserving consistence in such data includes: detecting that a first management appliance in the group has reverted to a snapshot thereof; and in response to such detecting, updating a desired state document for the group to remove data items in the desired state document that have been designated as local to the first management appliance, and instructing each of the management appliances in the group to apply the desired state document.

### RELATED APPLICATIONS

Benefit is claimed under 35 U.S.C. 119(a)-(d) to Foreign Application Serial No. 202241039112 filed in India entitled “RECOVERY OF MANAGEMENT APPLIANCE AFTER UPGRADE FAILURE WITHOUT CREATING DATA INCONSISTENCIES”, on Jul. 7, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration (e.g., VMware vSphere® vMotion®) between the hosts, distributed power management, dynamic VM placement according to affinity and anti-affinity rules, and high availability (HA) (e.g., VMware vSphere® High Availability). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

In some cases, management appliances of multiple SDDCs may be linked together using a feature known as enhanced linked mode (ELM). The linking of the management appliances allows an administrator to log into any one of the management appliances to view and manage the inventories of all of the SDDCs of the ELM group. To enable this feature, a change in the inventory data in any one of the management appliances needs to be replicated to all of other management appliances in the ELM group. The replication may be performed using a multi-master database system or as described in U.S. patent application Ser. No. 17/591,613, filed Feb. 3, 2022, the entire contents of which are incorporated herein, according to a desired state of the inventory data.

When the management appliances that are linked together undergo an upgrade, the upgrade is carried out one management appliance at a time. For each management appliance upgrade, the snapshots of all the management appliances that are linked together are taken, and then one management appliance is upgraded. The above two steps are repeated for each of the management appliances, and if there are any issues during or after the upgrade of any one management appliance, all of the management appliances are reverted to their snapshots and the above process is repeated after the issues are resolved. In the above process, all of the management appliances are reverted to their snapshots upon encountering an upgrade issue with any one management appliance, because a change in the inventory data in any one management appliance is replicated to all of other management appliances and so a reversion of just the management appliance encountering the upgrade issue could result in data inconsistencies.

### SUMMARY

One or more embodiment provide a method of recovering a management appliance after upgrade failure without creating data inconsistencies. In the one or more embodiments, consistency in data that are replicated across a group of management appliances is preserved even when one of the management appliances is reverted to a snapshot thereof. A method of preserving consistence in such data, according to an embodiment, includes: detecting that a first management appliance in the group has reverted to a snapshot thereof; and in response to such detecting, updating a desired state document for the group to remove data items in the desired state document that have been designated as local to the first management appliance, and instructing each of the management appliances in the group to apply the desired state document.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 depicts a cloud platform, and a plurality of SDDCs that are managed through the cloud platform, according to embodiments.

FIG. 3 illustrates a condensed version of a sample desired state document that includes an inventory data object.

FIG. 4 depicts the types of information that are stored in a database for the inventory data.

FIG. 5 depicts a sequence of commands that are issued and executed in response to an update to the database for the inventory data.

FIG. 6 illustrates a condensed version of a sample change document.

FIG. 7 is a flow diagram that illustrates the steps of a method for upgrading management appliances of a configuration group.

FIG. 8 is a flow diagram that illustrates the steps of a method for processing desired state changes reported by a management appliance and for preserving consistency in data that are replicated across the management appliances of the configuration group when one of the management appliances has reverted to a snapshot thereof.

### DETAILED DESCRIPTION

One or more embodiments provide a cloud platform from which various services, referred to herein as “cloud services” are delivered to the SDDCs through agents of the cloud services that are running in an appliance (referred to herein as a “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the respective agents of the cloud services.

The cloud platform according to one or more embodiments also manages replication of data across management appliances of SDDCs, according to a desired state defined in a declarative document referred to herein as a desired state document. In the embodiments illustrated herein, the desired state document is created in the form of a human readable and editable file, e.g., a JSON (JavaScript Object Notation) file, and consistency in data that are replicated across a group of management appliances is preserved even when one of the management appliances is reverted to a snapshot thereof. This is achieved by: (1) marking each of the data items in the desired state document with an identifier of the management appliance if the data item has been designated as local to that management appliance; and (2) when one of the management appliances has reverted to a snapshot thereof, updating the desired state document to remove data items in the desired state document that have been designated local to the reverted management appliance, and applying the updated desired state document to each of the management appliances in the group.

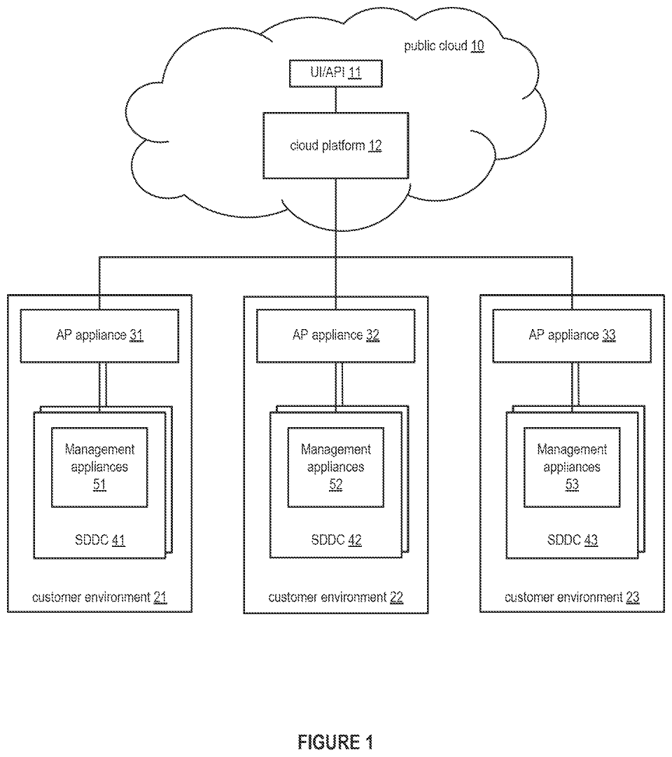

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) of cloud platform 12 is depicted in FIG. 1 as UI/API 11. The computing environment illustrated in FIG. 1 is sometimes referred to as a hybrid cloud environment because it includes a public cloud 10 and a customer environment (e.g., customer environment 21, 22, or 23).

A plurality of SDDCs is depicted in FIG. 1 in each of customer environment 21, customer environment 22, and customer environment 23. In each customer environment, the SDDCs are managed by respective management appliances, which include a virtual infrastructure management (VIM) server appliance (e.g., the VMware vCenter Server® appliance) for overall management of the virtual infrastructure, and a network management server appliance (e.g., the VMware NSX® appliance) for management of the virtual networks. For example, SDDC 41 of the first customer is managed by management appliances 51, SDDC 42 of the second customer by management appliances 52, and SDDC 43 of the third customer by management appliances 53.

The management appliances in each customer environment communicate with an agent platform appliance, which hosts agents that communicate with cloud platform 12 to deliver cloud services to the corresponding customer environment. The communication is over a local area network of the customer environment where the agent platform appliance is deployed. For example, management appliances 51 in customer environment 21 communicate with agent platform appliance 31 over a local area network of customer environment 21. Similarly, management appliances 52 in customer environment 22 communicate with agent platform appliance 32 over a local area network of customer environment 22, and management appliances 53 in customer environment 23 communicate with agent platform appliance 33 over a local area network of customer environment 23.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

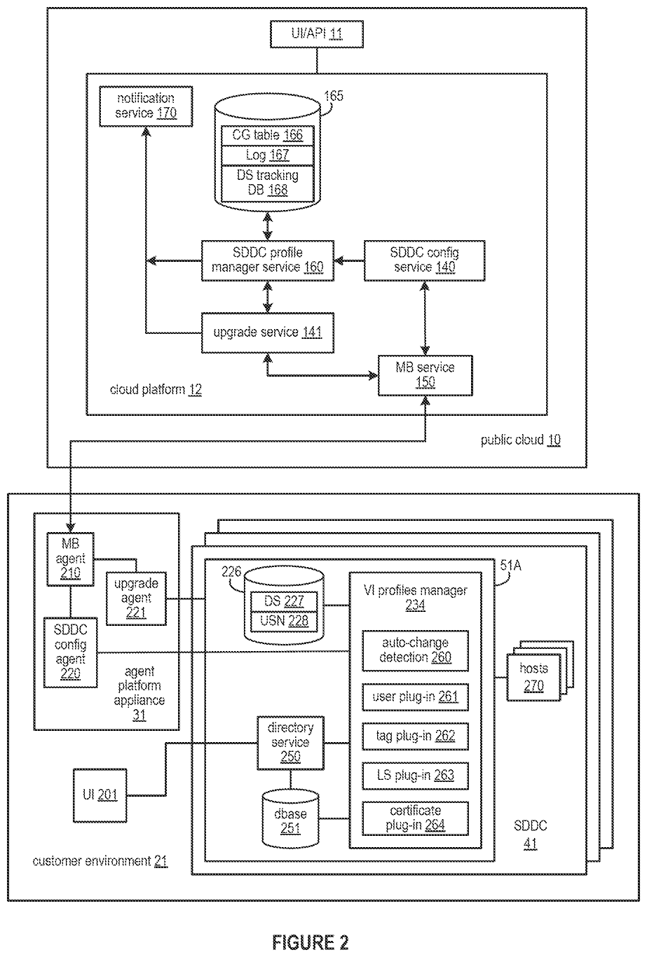

FIG. 2 illustrates components of cloud platform 12 and agent platform appliance 31 that are involved in managing the SDDCs according to a desired state. Cloud platform 12 is accessible by different customers through UI/API 11 and each of the different customers manage the configuration of its group of SDDCs through cloud platform 12 according to a desired state of the SDDCs that the customer defines in a desired state document. In FIG. 2, the management of the SDDCs in customer environment 21, in particular that of SDDC 41, is selected for illustration. It should be understood that the description given herein for customer environment 21 also apply to other customer environments, including customer environment 22 and customer environment 23.

Cloud platform 12 includes a group of services running in virtual infrastructure of public cloud 10 through which a customer can manage the desired state of its group of SDDCs by issuing commands through UI/API 11. SDDC configuration service 140 is responsible for accepting commands made through UI/API 11 and dispatching tasks to a particular customer environment through message broker (MB) service 150 to apply the desired state to the SDDCs. SDDC configuration service 140 is also responsible for processing changes to the desired state reported by the SDDCs, updating the desired state, and dispatching tasks to the SDDCs to apply the updated desired state to the SDDCs. Upgrade service 141 is responsible for carrying out an upgrade of the management appliances by dispatching tasks to a particular customer environment through MB service 150 to upgrade the management appliances. MB service 150 is responsible for exchanging messages with message broker (MB) agents deployed in different customer environments upon receiving a request to exchange messages from the MB agents. The communication between MB service 150 and the different MB agents is, for example, over a public network such as the Internet. SDDC profile manager service 160 is responsible for storing the desired state documents in data store 165 (e.g., a virtual disk or a depot accessible using a URL) and tracks the history of changes to the desired state document in a desired state tracking database 168 using a universal serial number (USN). The USN is a monotonically increasing number that is updated by remediation engine 141 as will be further described below. SDDC profile manager service 160 also maintains in data store 165 a configuration group table 166 and an interaction log 167. Configuration group table 166 identifies, for each configuration group, one or more management appliances (in particular, VIM server appliances) that belong to that configuration group. In the embodiments, inventory data is replicated across all of the management appliances in the same configuration group. Interaction log 167 identifies for each management appliance the USN associated with the latest desired state that has been applied to that management appliance.

Agent platform appliance 31 in customer environment 21 has various agents of cloud services running in cloud platform 12 deployed thereon. In the embodiments described herein, each of the cloud services is a microservice that is implemented as one or more container images executed on a virtual infrastructure of public cloud 10. Similarly, each of the agents and services deployed on the agent platform appliances is a microservice that is implemented as one or more container images executing in the agent platform appliances.

The three agents depicted in FIG. 2 include MB agent 210, SDDC configuration agent 220, and upgrade agent 221. MB agent 210 periodically polls MB service 150 to exchange messages with MB service 150, i.e., to receive messages from MB service 150 and to transmit to MB service 150 messages that it received from other agents deployed in agent platform appliance 31. If a message received from MB service 150 includes a task to apply the desired state, MB agent 210 routes the message to SDDC configuration agent 220. If a message received from MB service 150 includes a task to upgrade the management appliances, MB agent 210 routes the message to upgrade agent 221.

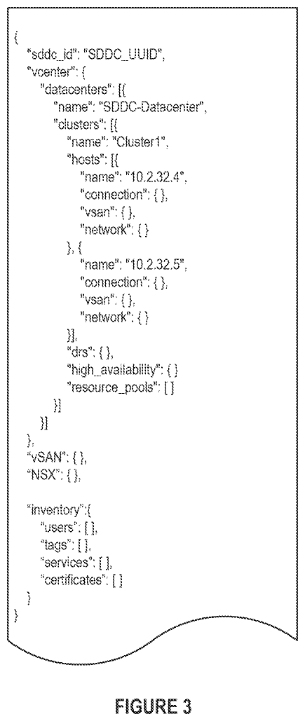

In the embodiments, the message that includes the task to apply the desired state, also includes a desired state diff document that contains all of the items of the desired state that needs to be applied to the SDDC, and a USN associated with the desired state document based on which the desired state diff document was generated. FIG. 3 illustrates a condensed version of a sample desired state document in JSON format, and includes entries for three management appliances of an SDDC identified as “SDDC UUID.” The three management appliances are identified as “vcenter,” which corresponds to VIM server appliance 51A depicted in FIG. 2, “NSX,” which corresponds to a network management appliance (not shown in FIG. 2), and “vSAN,” which corresponds to another of the managements appliances (not shown in FIG. 2).

The desired state document also includes inventory data, which is managed by directory service 250 of VIM server appliance 51A. The inventory data includes user data, tag data, look-up service (LS) data, and certificate data. The sample desired state document depicted in FIG. 3 has an inventory data object for the inventory data, and the inventory data object includes a separate array for each of user data, tag data, LS data, and certificate data. The inventory data is stored in a database 251, which is, e.g., a key-value database.

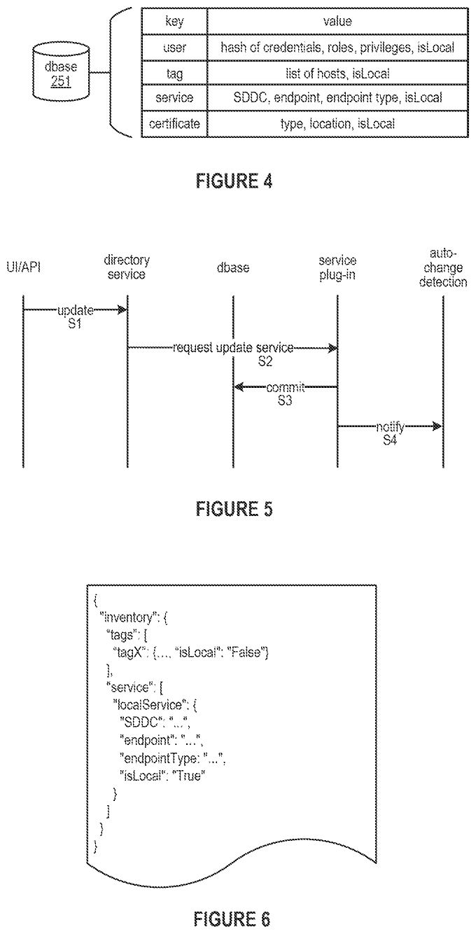

FIG. 4 depicts the different types of information that are stored in database 251 for each of user data, tag data, LS data, and certificate data. User data is stored in database 251 as a plurality of entries, one for each user, and each entry for a user contains the following information for the user: hash of credentials, roles, and privileges. Tag data is stored in database 251 as a plurality of entries, one for each tag, and each entry for a tag contains a list of hosts (in particular, host IDs) associated with the tag. LS data is stored in database 251 as a plurality of entries, one for each service, and each entry for a service contains the following information for the service: SDDC where the service is deployed, endpoint of the service, and the endpoint type. Certificate data is stored in database 251 as a plurality of entries, one for each certificate, and each entry for a certificate contains the following information for the certificate: type of certificate and location where the certificate is stored. The inventory data in database 251 is updated by service plug-ins installed in VI profiles manager 234. In particular, user data, tag data, LS data, and certificate data in database 251 are updated by user plug-in 261, tag plug-in 262, LS plug-in 263, and certificate plug-in 264, respectively.

The inventory data may be updated when VI profiles manager 234 receives an API call from SDDC configuration agent 220 to apply the desired state specified in the desired state diff document. In the embodiments, upon receiving the API call, VI profiles manager 234 applies the desired state by calling the respective plug-ins, updates the desired state document (depicted in FIG. 2 as DS 227) in data store 226 (which is, e.g., a virtual disk) by applying the changes to the desired state specified in the desired state diff document, and updates USN 228 that is saved in data store 226 with the USN which was sent with the message to apply the desired state.

The inventory data also may be updated when the inventory data is locally changed by the administrator of SDDC 41 through UI 201. In the embodiments, any local changes made to the inventory data are later to be replicated across all SDDCs, in particular to all VIM server appliances that are part of the same configuration group as VIM server appliance 51A, according to the desired state by sending a desired state change document that includes all local changes made to the desired state since the desired state was last applied to SDDC 41.

In general, any local changes made to the inventory data of any one of the VIM server appliances of a configuration group are replicated across all other VIM server appliances of the same configuration group by updating the desired state document to include the changes and applying the updated desired state document to all the other VIM server appliances of the same configuration group. As a result, user access to any VIM server appliance of a configuration group will be governed by the same user data regardless of which VIM server appliance of the configuration group that the user accesses. In addition, hosts that are located in different SDDCs can be managed as a single cluster as long as they are tagged with the same cluster ID, and a service in one SDDC can call a service in another SDDC by performing a look-up of LS data. Similarly, certificate data in one of the VIM server appliances of the configuration group are shared with other VIM server appliances of the configuration group so that a secure communication can be established with all SDDCs of the configuration group using the certificate data stored in database 251 and replicated across all VIM server appliances of the configuration group.

When local changes are made to the inventory data, the respective service plug-ins, user plug-in 261, tag plug-in 262, LS plug-in 263, and certificate plug-in 264, notify auto-change detection service 260 running in VI profiles manager 234 of the changes. Auto-change detection service 260 commits these changes to desired state document 227 stored in data store 226, increments the USN, and generates a change document that contains each of these changes along with metadata (“isLocal”: “True”) to indicate that the change is to a data item that is local to SDDC 41 (i.e., the data item that has been changed can only be modified by SDDC 41) or metadata (“isLocal”: “False”) to indicate that the change is to a data item that is global to all SDDC of the configuration group of SDDC 41 (i.e., the data item that has been changed can be modified by any SDDC of the configuration group of SDDC 41). After generating the change document, auto-change detection service 260 notifies SDDC configuration agent 220, which in turn prepares a message that contains a change event, the change document, and the USN for MB agent 210 to transmit to MB service 150.

FIG. 5 depicts a sequence of commands that are issued and executed in response to an update to database 251 that is initiated through UI 201. At step S1, in response to user inputs made through UI 201, which contain desired changes to database 251, an update command is issued to directory service 250. Directory service 250 then calls the service plug-in(s) corresponding to the desired changes at step S2. For example, if tag data is being updated, directory service 250 calls tag plug-in 262. The corresponding service plug-in at step S3 commits the changes to database 251, and at step S4 notifies auto-change detection service 260 of the changes made to database 251.

FIG. 6 illustrates a condensed version of a sample change document in JSON format. The change document illustrated in FIG. 6 assumes that the only changes to the desired state document are to the inventory object, in particular to a tag, tagX which is a data item that is designated as global (and therefore “isLocal”: “False”) and to a service, localService, which is a data item that is designated as local (and therefore “isLocal”: “True”).

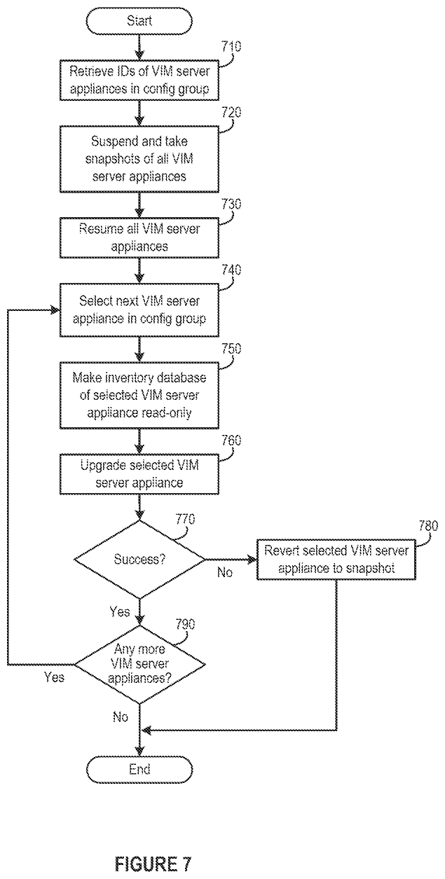

FIG. 7 is a flow diagram that illustrates the steps of a method for upgrading management appliances, in particular VIM server appliances, of a particular configuration group. This method is carried out by upgrade cloud service 141 running in cloud platform 12 through upgrade agent 221 deployed in agent platform appliance 31. The method of FIG. 7 begins at step 710 at which upgrade cloud service 141 retrieves IDs of all VIM sever appliances of the target configuration group and instructs upgrade agent 221 through the message fabric (which includes MB service 150 and MB agent 210) to perform the upgrade of these VIM server appliances. In one embodiment, the configuration group data that contains, for each configuration group, a listing of the IDs of all the VIM sever appliances that are part of that configuration group, is maintained by SDDC profile manager service 160 in data store 165 (e.g., in configuration group table 166).

At step 720, upgrade agent 221 instructs all of the VIM server appliances of the configuration group to suspend their execution and invokes an API of a snapshot service (not shown) to take a snapshot of each of the VIM server appliances of the configuration group. Then, at step 730, upgrade agent 221 instructs all of the VIM server appliances of the configuration group to resume execution. After the VIM server appliances of the configuration group have resumed execution, upgrade agent 221 selects one VIM server appliance in the configuration group to upgrade at step 740. Then, upgrade agent 221 invokes an API of the selected VIM server appliance to make the database containing the inventory data (e.g., database 251) read-only at step 750, so that it cannot be updated while the VIM server appliance is being upgraded. Then, upgrade agent 221 performs an upgrade of the selected VIM server appliance at step 760. The upgrade at step 760 is carried out in the manner described in U.S. patent application Ser. No. 17/670,544, filed Feb. 14, 2022, or in U.S. patent application Ser. No. 17/741,496, filed May 11, 2022, both of which are incorporated by reference herein.

If the upgrade is not successful (step 770, No), upgrade agent 221 reverts the selected VIM server appliance to its snapshot at step 780. Depending on how much time has elapsed since step 720, this may cause the USN of this VIM server appliance to be rolled back to a prior USN when its snapshot was taken at step 720. The upgrade process ends after step 780. On the other hand, if the upgrade is successful (step 770, Yes), the upgrade process continues if there are more VIM server appliances of the configuration group to upgrade (Step 790, Yes), and ends if there are no more VIM server appliances of the configuration group to upgrade (Step 790, No). In some situations, the failure in the upgrade of a VIM server appliance is discovered asynchronously to step 760. In such cases, step 780 is still carried out for that VIM server appliance.

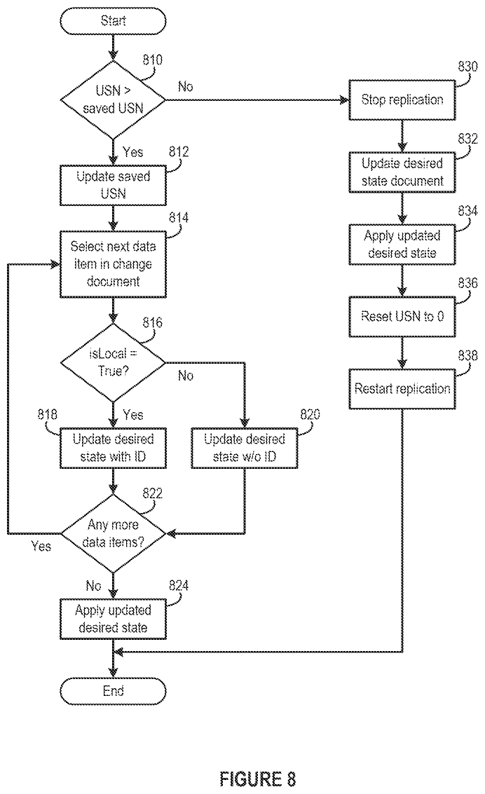

FIG. 8 is a flow diagram that illustrates the steps for processing desired state changes reported by a management appliance, in particular a VIM server appliance, and for preserving consistency in data that are replicated across all VIM server appliances of the configuration group when one of the VIM server appliances has reverted to a snapshot thereof. The method of FIG. 8 begins at step 810 when a change event, a change document described above (containing changes to the desired state), and a USN are reported by a VIM server appliance through its respective SDDC configuration agent, MB agent, and MB service 150. Upon receipt of this change event, SDDC configuration service 140 compares the reported USN with a USN that has been saved in association with an ID of the reporting VIM server appliance. In one embodiment, the USNs of each of the VIM server appliances are saved in data store 165 (e.g., interaction log 167) by SDDC profile manager service 160, and the initial values of these USNs are zero.

If the reported USN is greater than the saved USN (step 810; Yes), SDDC configuration service 140 determines that the VIM server appliance is operating normally and the process continues onto step 812. At 812, SDDC configuration service 140 instructs SDDC profile manager service 160 to update the saved USN for the reporting VIM server appliance. Then, SDDC configuration service 140 processes each changed data item in the change document one by one. After selecting a changed data item that has not yet been processed at step 814, SDDC configuration service 140 determines at step 816 if the “isLocal” metadata is “True.” If so, SDDC configuration service 140 at step 818 updates the desired state document to incorporate the changed data item and tags the data item with the ID of the VIM server appliance. If not, SDDC configuration service 140 at step 820 updates the desired state document to incorporate the changed data item without the tagging described above. At step 822, SDDC configuration service 140 checks to see if there are any more changed data items to process. If so, the process returns to step 814. If not, step 824 is executed where SDDC configuration service 140 applies the updated desired state document to all VIM server appliances that are in the same configuration group as the reporting VIM server appliance. In one embodiment, SDDC configuration service 140 prepares a desired state diff document for each VIM server appliance by performing a diff operation between the desired state document that was last applied to the VIM server appliance and the current desired state document of the configuration group, and then sends a message containing the task to apply the desired state, the desired state diff document, and the USN of the current desired state to the VIM server appliance through MB service 150, MB agent 210, and SDDC configuration agent 220.

Returning to step 810, if the reported USN is not greater than the saved USN (Step 810; No), SDDC configuration service 140 determines that the VIM server appliance has reverted to its snapshot and the process continues to step 830. At step 830, SDDC configuration service 140 sends a message to the VIM server appliance through MB service 150, MB agent 210, and SDDC configuration agent 220 to stop replication of its inventory data. Then, at step 832, SDDC configuration service 140 updates the desired state document to remove all data items marked with the ID of the reporting VIM server appliance. After updating the desired state document, SDDC configuration service 140 dispatches tasks to all the VIM server appliances of the configuration group (of the reporting VIM server appliance) to apply the changes specified in the desired state diff document prepared for the VIM server appliance to the current desired state of the VIM server appliance. At step 836, SDDC configuration service 140 resets the USN of the reporting VIM server appliance to zero and instructs SDDC profile manager service 160 to save the USN of the reporting VIM server appliance that has been reset to zero. Then, at step 838, SDDC configuration service 140 sends a message to the VIM server appliance through MB service 150, MB agent 210, and SDDC configuration agent 220 to restart replication of its inventory data. The method ends after step 838.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of preserving consistency in data that are replicated across a group of management appliances when one of the management appliances is reverted to a snapshot thereof, said method comprising:
detecting that a first management appliance in the group has reverted to a snapshot thereof; and
in response to said detecting, updating a desired state document for the group to remove the items in the desired state document that have been designated as local to the first management appliance, and instructing each of the management appliances in the group to apply the desired state document.

2. The method of claim 1, further comprising:
after said detecting and prior to said updating, instructing the first management appliance to stop sending changes to the desired state document; and
after said instructing, instructing the first management appliance to resume sending changes to the desired state document.

3. The method of claim 2, further comprising:
after instructing the first management appliance to resume sending changes to the desired state document, updating the desired state document according to the changes to the desired state document sent by the first management appliance; and
instructing each of the management appliances in the group to apply the updated desired state document.

4. The method of claim 3, wherein
the changes include a first change that is a local change and a second change that is a global change, and
the desired state document is updated to store the first change with an identifier of the first management appliance and to store the second change without the identifier of the first management appliance.

5. The method of claim 1, wherein
the desired state document includes data items that have been designated as local to one of the management appliances and data items that are global, and
the data items that have been designated as local to the management appliances in the group other than the first management appliance are not removed from the desired state document during said updating.

6. The method of claim 1, further comprising:
storing a universal serial number separately for each of the management appliances; and
for each of the management appliances, upon receiving a new universal serial number from the management appliance, updating the stored universal serial number thereof with the new universal serial number if the new universal serial number is greater than the stored universal serial number thereof, and storing a universal serial number of zero as the universal serial number thereof if the new universal serial number is less than the stored universal serial number thereof.

7. The method of claim 6, wherein the first management appliance is detected to have reverted to the snapshot thereof as a result of determining that the new universal serial number received from the first management appliance is less than the stored universal serial number of the first management appliance.

8. A non-transitory computer readable medium comprising instructions to be executed in a computer system to carry out a method of preserving consistency in data that are replicated across a group of management appliances when one of the management appliances is reverted to a snapshot thereof, said method comprising:
detecting that a first management appliance in the group has reverted to a snapshot thereof; and
in response to said detecting, updating a desired state document for the group to remove the items in the desired state document that have been designated as local to the first management appliance, and instructing each of the management appliances in the group to apply the desired state document.

9. The non-transitory computer readable medium of claim 8, wherein the method further comprises:
after said detecting and prior to said updating, instructing the first management appliance to stop sending changes to the desired state document; and
after said instructing, instructing the first management appliance to resume sending changes to the desired state document.

10. The non-transitory computer readable medium of claim 9, wherein the method further comprises:
after instructing the first management appliance to resume sending changes to the desired state document, updating the desired state document according to the changes to the desired state document sent by the first management appliance; and
instructing each of the management appliances in the group to apply the updated desired state document.

11. The non-transitory computer readable medium of claim 10, wherein
the changes include a first change that is a local change and a second change that is a global change, and
the desired state document is updated to store the first change with an identifier of the first management appliance and to store the second change without the identifier of the first management appliance.

12. The non-transitory computer readable medium of claim 8, wherein
the desired state document includes data items that have been designated as local to one of the management appliances and data items that are global, and
the data items that have been designated as local to the management appliances in the group other than the first management appliance are not removed from the desired state document during said updating.

13. The non-transitory computer readable medium of claim 8, wherein the method further comprises:
storing a universal serial number separately for each of the management appliances; and
for each of the management appliances, upon receiving a new universal serial number from the management appliance, updating the stored universal serial number thereof with the new universal serial number if the new universal serial number is greater than the stored universal serial number thereof, and storing a universal serial number of zero as the universal serial number thereof if the new universal serial number is less than the stored universal serial number thereof.

14. The non-transitory computer readable medium of claim 13, wherein the first management appliance is detected to have reverted to the snapshot thereof as a result of determining that the new universal serial number received from the first management appliance is less than the stored universal serial number of the first management appliance.

15. A cloud platform for managing the replication of data across a group of management appliances when one of the management appliances is reverted to a snapshot thereof, wherein the cloud platform is programmed to carry out the steps of:
detecting that a first management appliance in the group has reverted to a snapshot thereof; and
in response to said detecting, updating a desired state document for the group to remove the items in the desired state document that have been designated as local to the first management appliance, and instructing each of the management appliances in the group to apply the desired state document.

16. The cloud platform of claim 15, wherein the steps further comprise:
after said detecting and prior to said updating, instructing the first management appliance to stop sending changes to the desired state document; and
after said instructing, instructing the first management appliance to resume sending changes to the desired state document.

17. The cloud platform of claim 16, wherein the steps further comprise:
after instructing the first management appliance to resume sending changes to the desired state document, updating the desired state document according to the changes to the desired state document sent by the first management appliance; and
instructing each of the management appliances in the group to apply the updated desired state document.

18. The cloud platform of claim 17, wherein
the changes include a first change that is a local change and a second change that is a global change, and
the desired state document is updated to store the first change with an identifier of the first management appliance and to store the second change without the identifier of the first management appliance.

19. The cloud platform of claim 15, wherein the steps further comprise:
storing a universal serial number separately for each of the management appliances; and
for each of the management appliances, upon receiving a new universal serial number from the management appliance, updating the stored universal serial number thereof with the new universal serial number if the new universal serial number is greater than the stored universal serial number thereof, and storing a universal serial number of zero as the universal serial number thereof if the new universal serial number is less than the stored universal serial number thereof.

20. The cloud platform of claim 19, wherein the first management appliance is detected to have reverted to the snapshot thereof as a result of determining that the new universal serial number received from the first management appliance is less than the stored universal serial number of the first management appliance.
